(19) United States
(12) Patent Application Publication
(10) Pub. No.: US 2016/0381644 A1
(43) Pub. Date: Dec. 29, 2016

(54) TECHNIQUES FOR CONTROLLING TRANSMIT POWER OF A USER EQUIPMENT OPERATING IN A WIRELESS COMMUNICATION SYSTEM

(71) Applicant: QUALCOMM Incorporated, San Diego, CA (US)

(72) Inventors: John FORRESTER, San Diego, CA (US); Sumit VERMA, San Diego, CA (US); Arvind SANTHANAM, San Diego, CA (US)

(21) Appl. No.: 15/162,915

(22) Filed: May 24, 2016

Related U.S. Application Data
(60) Provisional application No. 62/185,402, filed on Jun. 26, 2015.

(51) Int. Cl. H04W 52/28; H04W 52/36; H04W 4/02; H04W 52/22; H04W 72/04

(52) U.S. Cl. CPC H04W 52/283; H04W 52/221; H04W 72/0413; H04W 72/0453; H04W 4/025; H04W 52/367

(57) ABSTRACT

Certain aspects relate to controlling a transmit power of a user equipment (UE) in a wireless communication network. The UE may determine a location of the UE, and identify, from set of transmit power reduction settings stored at the UE, a power reduction indicator corresponding to the location and to a frequency range of an uplink transmission. Further, the aspects include the UE transmitting a first uplink transmission in the frequency range at a first transmit power controlled based on the power reduction indicator when the power reduction indicator is found. In another aspect, the UE transmits a second uplink transmission in the frequency range at a second transmit power controlled based on a network-signaled power reduction value when the power reduction indicator corresponding to the location is not found at the UE.

### RELATED APPLICATIONS

This application claims priority from U.S. Provisional Application No. 62/185,402 entitled “CONTROLLING TRANSMIT POWER OF A USER EQUIPMENT,” filed on Jun. 26, 2015, which is incorporated herein by reference in its entirety.

### FIELD OF THE DISCLOSURE

The present disclosure relates to, for example, wireless communication systems, and more particularly, to techniques for controlling a transmit power of a user equipment operating in a wireless communication system.

### BACKGROUND OF THE DISCLOSURE

Wireless communication networks are widely deployed to provide various communication services, such as voice, video, packet data, messaging, broadcast, etc., to one or more user equipment (UE), also referred to as wireless communication devices. These wireless networks may be multiple-access networks capable of supporting multiple UEs by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, and Long Term Evolution (LTE) networks.

Before a UE can be marketed and sold in a country, a radio regulatory certification must be completed. For example, in the United States, a UE must complete a

Federal Communications Commission (FCC) radio authorization. Each country has a unique radio regulator that defines radio requirements, references another country for regulatory emissions requirements and/or regulatory RF exposure requirement and/or any other regulatory requirements related to uplink transmission from the UE, or references industry standards as the requirements that must be met to demonstrate compliance with the countries radio law. Although radio requirements are often consistent between countries and based on either FCC or European requirements, there are exceptions where a specific country has unique radio requirements for various reasons. For example, in the United States, certain mobile frequency bands have more stringent radio frequency (RF) emissions requirements compared to other countries in order to protect specific services in the United States from interference sourced from one or more UEs.

UE manufacturers are thus challenged with designing a device that complies with all international regulatory emissions requirements and/or regulatory RF exposure requirements and/or any other regulatory requirements related to uplink transmission from the UE. The 3rd Generation Partnership Project (3GPP) has defined a mechanism in the Technical Standard 36.101 where LTE UEs can be designed to comply with regional requirements. This is beneficial for a UE manufacturer, as they can design a UE that will transmit at higher power in markets with relaxed RF emissions requirements and reduce transmit power to comply with regional specific regulatory emissions requirements and/or regulatory RF exposure requirements and/or any other regulatory requirements related to uplink transmission from the UE. The 3GPP mechanism, however, relies on receiving correct signaling from the network. Thus, improvements in control of UE transmit power are desired.

### SUMMARY OF THE DISCLOSURE

In accordance with an aspect, a method for controlling a transmit power of a user equipment (UE) in a wireless communication network is provided. The method includes determining, at a processor of the UE, a location of the UE, and identifying, from a set of transmit power reduction settings stored in a memory of the UE, a power reduction indicator corresponding to the location and to a frequency range of an uplink transmission by the UE. Further, the method may include transmitting, by a transmitter of the UE, a first uplink transmission in the frequency range at a first transmit power controlled based on the power reduction indicator. The method may further include transmitting, at the transmitter, a second uplink transmission in the frequency range at a second transmit power controlled based on a network-signaled power reduction value received by a receiver of the UE when the power reduction indicator is not found in the memory of the UE for a second location.

In another aspect, a user equipment (UE) controls a transmit power of the UE for transmitting communications in a wireless communication network. The UE may include a memory having a set of transmit power reduction settings including one or more power reduction indicators each corresponding to location information and a transmit frequency range. The UE may include a processor having a transmit power control component. The processor may be configured to determine a location of the UE and check the set of transmit power reduction settings stored in the memory of the UE to determine a respective power reduction indicator corresponding to the location and corresponding to a frequency range of an uplink transmission by the UE. The UE may include a transmitter configured to transmit a first uplink transmission in the frequency range at a first transmit power controlled based on the power reduction indicator.

In another aspect, another UE controls a transmit power of the UE for transmitting communications in a wireless communication network. The UE may include means for determining a location of the UE. The UE may include means for checking a set of transmit power reduction settings stored in a memory of the UE to determine a maximum power reduction indicator for the location and for a frequency range of an uplink transmission from the UE. The UE may further include means for transmitting at a transmit power level based on the maximum power reduction indicator stored at the UE.

In another aspect, a computer-readable storage medium stores computer-executable code for controlling a transmit power of a UE in a wireless communication network. The computer-readable storage medium may include code executable by a processor to determine a location of the UE. The computer-readable storage medium may include code executable by the processor to check a set of transmit power reduction settings stored in a memory of the UE to determine a maximum power reduction indicator for the location and for a frequency range of a transmission from the UE. The computer-readable storage medium further includes code executable by the processor to transmit at a transmit power level based on the maximum power reduction indicator stored in the memory of the UE.

Various aspects and features are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 is a block diagram conceptually illustrating a wireless communications system, including a transmit power control component in accordance with various aspects of the present disclosure.

FIG. 2 is a block diagram conceptually illustrating an eNodeB and a UE configured to include including a transmit power control component in accordance with various aspects of the present disclosure.

FIG. 3 is a schematic block diagram of the UE of FIGS. 1 and 2 and additional details of components included in or relating to the transmit power control component in accordance with various aspects of the present disclosure.

FIG. 4 is a flowchart of a method for controlling the UE transmit power, which may be implemented by operation of the transmit power control component in accordance with various aspects of the present disclosure.

FIG. 5 is a schematic block diagram of the UE of FIG. 3, but with additional details and additional components associated with the transmit power control component in accordance with various aspects of the present disclosure.

FIG. 6 is a schematic block diagram of transmit power reduction settings that may be used by the transmit power control component in accordance with various aspects of the present disclosure.

FIG. 7 is a block diagram of an example hardware implementation for an apparatus employing a processing system configured with the transmit power control component in accordance with various aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Various methods, apparatuses, devices, and systems are described for UE-based control of a transmit power of a UE, for example, to ensure uplink transmissions from the UE meet regulatory emissions requirements and/or regulatory RF exposure requirements and/or any other regulatory requirements related to uplink transmission from the UE that are associated with a current location and transmit frequency range used by the UE. In particular, the UE may store transmit power reduction settings in memory, where the transmit power reduction settings include one or more transmit power reduction indicators corresponding to one or more locations and one or more frequency ranges. For instance, in one implementation, the transmit power reduction indicators may be or may correspond to respective network signaling (NS) values as specified by 3GPP technical specifications, such as TS 36.101, and thus may correspond to respective Additional Maximum Power Reduction (A-MPR) values used to meet regulatory emissions requirements and/or regulatory RF exposure requirements and/or any other regulatory requirements related to uplink transmission from the UE. In any case, when found in the stored transmit power reduction settings, the UE can use the respective transmit power reduction indicator to set a transmit configuration and perform a transmission in the frequency range in a manner that meets regulatory emissions requirements and/or regulatory RF exposure requirements and/or any other regulatory requirements related to uplink transmission from the UE. As such, the present aspects enable UE control over transmit power reduction settings, for example, to ensure that regulatory emissions requirements and/or regulatory RF exposure requirements and/or any other regulatory requirements related to uplink transmission from the UE are met. Accordingly, the present aspects may avoid reliance on network operator compliance with providing network-signaled power reduction values that meet regulatory emissions requirements and/or regulatory RF exposure requirements and/or any other regulatory requirements related to uplink transmission from the UE.

In other words, in one implementation, the described aspects specially configure a UE to ensure compliance with regional regulatory emissions requirements and/or regulatory RF exposure requirements and/or any other regulatory requirements related to uplink transmission from the UE, which may also include fully complying with 3GPP conformance requirements and test procedures. For example, in some implementations, the described aspects may use transmit power reduction settings that include the 3GPP defined Network Signaling (NS) and Additional Maximum Power Reduction (A-MPR) values for regulatory compliance independent of a LTE network signaling configuration. This may be achieved by the UE determining a current location and transmit frequency range, such as based on Global Positioning System (GPS) operation or based on reading the Mobile Country Code (MCC) broadcasted by a LTE network and determining if A-MPR is required for regulatory compliance in the respective current location. If A-MPR is required, the UE operates as if the NS value is signaled from LTE network in the downlink, e.g., based on the stored transmit power reduction indicator, but without actually having to check if the received NS value is the proper NS value for the location and frequency range. As such, and in some cases where regulatory agencies accept that LTE networks properly deploy MCC codes, eliminating the configurable NS value transmitted by the LTE network as a compliance dependency allows regulators to accept UEs based on inherent behavior, e.g., based on operation of the present aspects, when the UE is operated in a specific country/region/location.

In another scenario, implementation of the present aspects may also avoid impacting international markets with 3GPP requirement-based and procedure-based industry and carrier conformance testing, as the additional power reduction may only be encountered if the stored transmit power reduction settings are configured for operation in a specific country where location based A-MPR is required. For example, a UE may be tested in a first location and determines to use A-MPR based on the stored transmit power reduction settings. When the same UE travels to a second location where network-signaled A-MPR is allowed, the stored transmit power reduction settings may not include a transmit power reduction indicator, and the UE may use a network-signaled power reduction indicator. Accordingly, the UE may satisfy conformance testing in multiple locations applying different regulations and testing methods.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of UMTS. 3GPP LTE and LTE-Advanced (LTE-A) are new releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

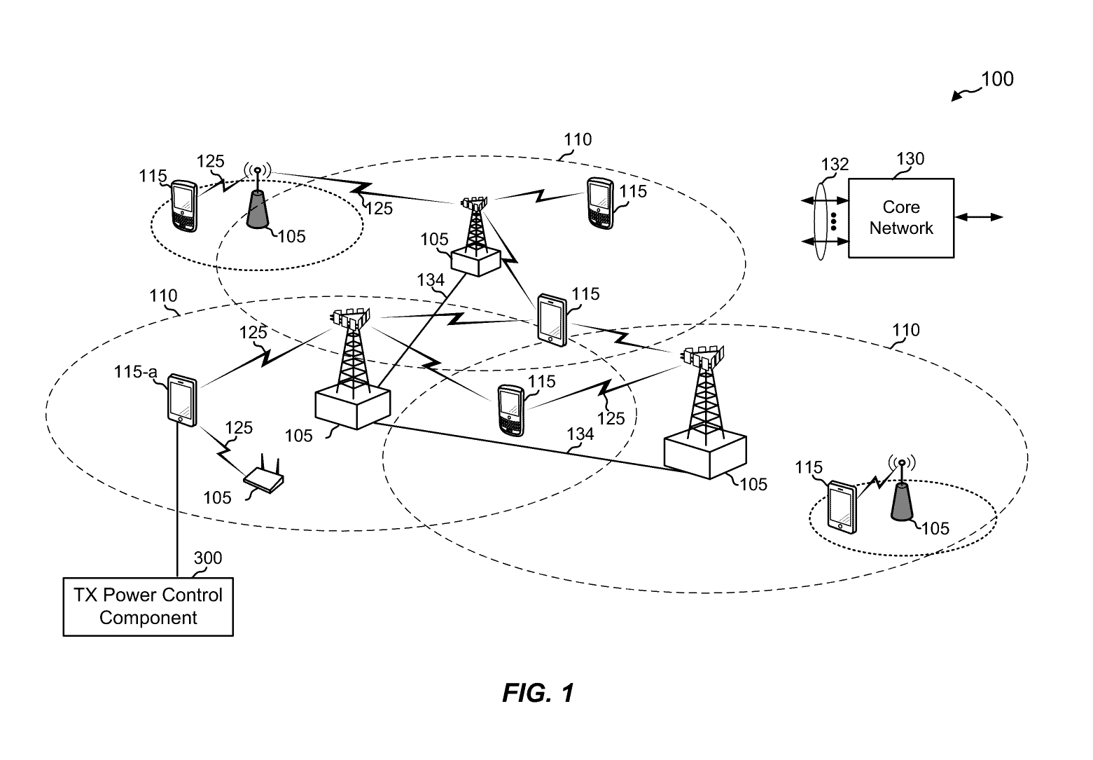

FIG. 1 is a block diagram conceptually illustrating an example of a wireless communications system 100, including a UE 115-a specially configured with a transmit power control component 300 that operates in accordance with various aspects of the present disclosure described herein. In particular, transmit power control component 300 provides UE-based control of a transmit power of the UE 115-a, for example, to ensure uplink transmissions from UE 115 meet regulatory emissions requirements and/or regulatory RF exposure requirements and/or any other regulatory requirements related to uplink transmission from the UE 115-a that are associated with a current location and transmit frequency range used by the UE 115-a, as described in more detail below. The wireless communications system 100 includes eNodeBs (or cells) 105, user equipment (UEs) 115, and a core network 130. The eNodeBs 105 may communicate with the UEs 115 under the control of a base station controller (not shown), which may be part of the core network 130 or the eNodeBs 105 in various embodiments. The eNodeBs 105 may communicate control information and/or user data with the core network 130 through first backhaul links 132. In embodiments, the eNodeBs 105 may communicate, either directly or indirectly, with each other over second backhaul links 134, which may be wired or wireless communication links. The wireless communications system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc. The wireless communications system 100 may also support operation on multiple flows at the same time. In some aspects, the multiple flows may correspond to multiple wireless wide area networks (WWANs) or cellular flows. In other aspects, the multiple flows may correspond to a combination of WWANs or cellular flows and wireless local area networks (WLANs) or Wi-Fi flows.

The eNodeBs 105 may wirelessly communicate with the UEs 115 via one or more base station antennas. Each of the eNodeBs 105 sites may provide communication coverage for a respective geographic coverage area 110. In some implementations, the eNodeBs 105 may be referred to as a base transceiver station, a radio base station, an access point, a radio transceiver, a basic service set (BSS), an extended service set (ESS), a NodeB, eNodeB, Home NodeB, a Home eNodeB, or some other suitable terminology. The geographic coverage area 110 for a respective eNodeB 105 may be divided into sectors making up only a portion of the coverage area (not shown). The wireless communications system 100 may include eNodeBs 105 of different types (e.g., macro, micro, pico, and/or femto base stations). There may be overlapping coverage areas for different technologies.

In implementations, the wireless communications system 100 is an LTE/LTE-A network communication system. In LTE/LTE-A network communication systems, the terms evolved Node B (eNodeB) may be generally used to describe the eNodeBs 105. The wireless communications system 100 may be a Heterogeneous LTE/LTE-A network in which different types of eNodeBs provide coverage for various geographical regions. For example, each eNodeB 105 may provide communication coverage for a macro cell, a micro cell, a pico cell, a femto cell, and/or other types of cell. A macro cell may cover a relatively large geographic area (e.g., several kilometers in radius) and may allow unrestricted access by the UEs 115 with service subscriptions with the network provider. A pico cell may cover a relatively smaller geographic area (e.g., buildings) and may allow unrestricted access by the UEs 115 with service subscriptions with the network provider. A femto cell may cover a relatively small geographic area (e.g., a home) and, in addition to unrestricted access, may also provide restricted access by the UEs 115 having an association with the femto cell (e.g., the UEs 115 in a closed subscriber group (CSG), the UEs 115 for users in the home, and the like). An eNodeB 105 for a macro cell may be referred to as a macro eNodeB. An eNodeB 105 for a pico cell may be referred to as a pico eNodeB. And, an eNodeB 105 for a femto cell may be referred to as a femto eNodeB or a home eNodeB. An eNodeB 105 may support one or multiple (e.g., two, three, four, and the like) cells. The wireless communications system 100 may support use of LTE and WLAN or Wi-Fi by one or more of the UEs 115.

The core network 130 may communicate with the eNodeBs 105 or other eNodeBs 105 via first backhaul links 132 (e.g., S1 interface, etc.). The eNodeBs 105 may also communicate with one another, e.g., directly or indirectly via second backhaul links 134 (e.g., X2 interface, etc.) and/or via the first backhaul links 132 (e.g., through core network 130). The wireless communications system 100 may support synchronous or asynchronous operation. For synchronous operation, the eNodeBs 105 may have similar frame timing, and transmissions from different eNodeBs 105 may be approximately aligned in time. For asynchronous operation, the eNodeBs 105 may have different frame timing, and transmissions from different eNodeBs 105 may not be aligned in time. The techniques described herein may be used for either synchronous or asynchronous operations.

The UEs 115 may be dispersed throughout the wireless communications system 100, and each UE 115 may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE 115 may be able to communicate with macro eNodeBs, pico eNodeBs, femto eNodeBs, relays, and the like.

The communication links 125 shown in the wireless communications system 100 may include uplink (UL) transmissions from a UE 115 to an eNodeB 105, and/or downlink (DL) transmissions, from an eNodeB 105 to a UE 115. The downlink transmissions may also be called forward link transmissions while the uplink transmissions may also be called reverse link transmissions.

In certain aspects of the wireless communications system 100, a UE 115 may be configured to support carrier aggregation (CA) or multiple connectivity wireless communications with two or more cells provided by one or more eNodeBs 105. The eNodeBs 105 that are used for CA/multiple connectivity wireless communications may be collocated or may be connected through fast connections and/or non-collocated. In either case, coordinating the aggregation of component carriers (CCs) for wireless communications between the UE 115 and the eNodeBs 105 may be carried out more easily because information can be readily shared between the various cells being used to perform the carrier aggregation.

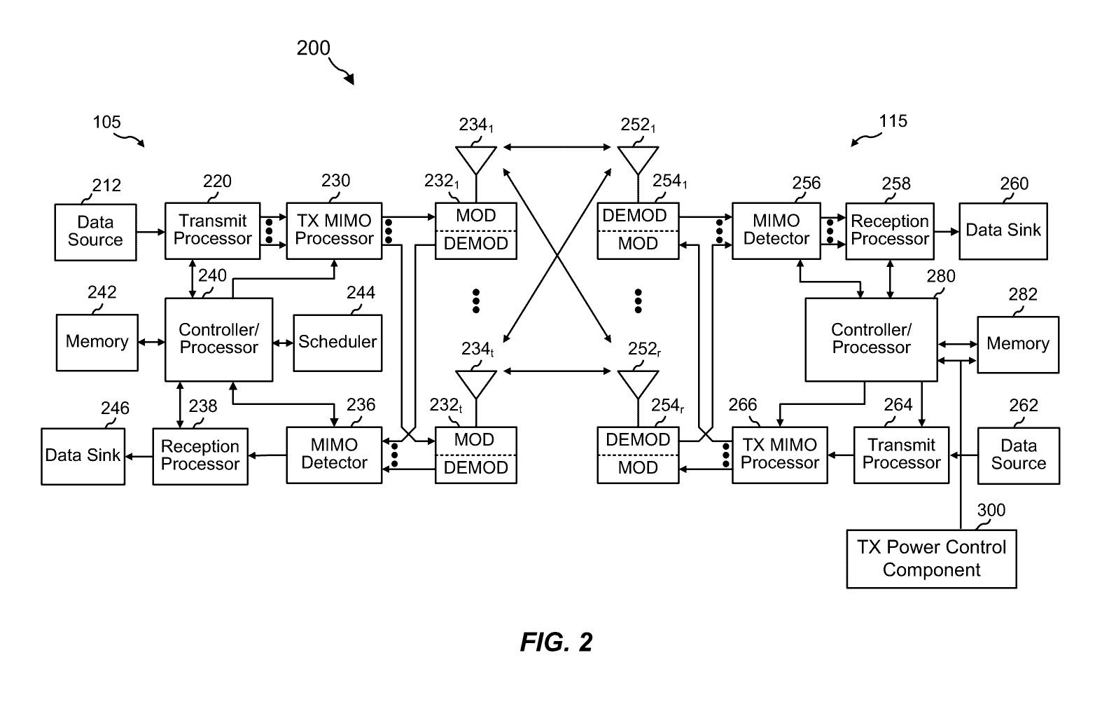

FIG. 2 is a block diagram conceptually illustrating examples of an eNodeB 105 and a UE 115 configured in accordance with an aspect of the present disclosure. For example, the eNodeB 105 and the UE 115 of a system 200, as shown in FIG. 2, may be one of the eNodeBs and one of the UEs in FIG. 1, respectively. Thus, for example, the UE 115 can include transmit power control component 300 that operates in accordance with various aspects of the present disclosure described herein. In particular, transmit power control component 300 provides UE-based control of a transmit power of the UE 115, for example, to ensure uplink transmissions from the UE 115 meet regulatory emissions requirements and/or regulatory RF exposure requirements and/or any other regulatory requirements related to uplink transmission from the UE that are associated with a current location and transmit frequency range used by the UE 115, as described in more detail below. The eNodeB 105 may be equipped with antennas 234₁₋ₜ, and the UE 115 may be equipped with antennas 252₁₋ᵣ, wherein t and r are integers greater than or equal to one.

At the eNodeB 105, a eNodeB transmit processor 220 may receive data from a eNodeB data source 212 and control information from a eNodeB controller/processor 240. The control information may be carried on the PBCH, PCFICH, physical hybrid automatic repeat/request (HARQ) indicator channel (PHICH), PDCCH, etc. The data may be carried on the PDSCH, etc. The eNodeB transmit processor 220 may process (e.g., encode and symbol map) the data and control information to obtain data symbols and control symbols, respectively. The eNodeB transmit processor 220 may also generate reference symbols, e.g., for the PSS, SSS, and cell-specific reference signal (RS). A eNodeB transmit (TX) multiple-input multiple-output (MIMO) processor 230 may perform spatial processing (e.g., precoding) on the data symbols, the control symbols, and/or the reference symbols, if applicable, and may provide output symbol streams to the eNodeB modulators/demodulators (MODs/DEMODs) 232₁₋ₜ. Each eNodeB modulator/demodulator 232 may process a respective output symbol stream (e.g., for OFDM, etc.) to obtain an output sample stream. Each eNodeB modulator/demodulator 232 may further process (e.g., convert to analog, amplify, filter, and upconvert) the output sample stream to obtain a downlink signal. Downlink signals from modulators/demodulators 232₁₋ₜ may be transmitted via the antennas 234₁₋ₜ, respectively.

At the UE 115, the UE antennas 252₁₋ᵣ may receive the downlink signals from the eNodeB 105 and may provide received signals to the UE modulators/demodulators (MODs/DEMODs) 254₁₋ᵣ, respectively. Each UE modulator/demodulator 254 may condition (e.g., filter, amplify, downconvert, and digitize) a respective received signal to obtain input samples. Each UE modulator/demodulator 254 may further process the input samples (e.g., for OFDM, etc.) to obtain received symbols. A UE MIMO detector 256 may obtain received symbols from all the UE modulators/demodulators 254₁₋ᵣ, and perform MIMO detection on the received symbols if applicable, and provide detected symbols. A UE reception processor 258 may process (e.g., demodulate, deinterleave, and decode) the detected symbols, provide decoded data for the UE 115 to a UE data sink 260, and provide decoded control information to a UE controller/processor 280.

On the uplink, at the UE 115, a UE transmit processor 264 may receive and process data (e.g., for the PUSCH) from a UE data source 262 and control information (e.g., for the PUCCH) from the UE controller/processor 280. The UE transmit processor 264 may also generate reference symbols for a reference signal. The symbols from the UE transmit processor 264 may be precoded by a UE TX MIMO processor 266 if applicable, further processed by the UE modulator/demodulators 2541, (e.g., for SC-FDM, etc.), and transmitted to the eNodeB 105. At the eNodeB 105, the uplink signals from the UE 115 may be received by the eNodeB antennas 234, processed by the eNodeB modulators/demodulators 232, detected by a eNodeB MIMO detector 236 if applicable, and further processed by a eNodeB reception processor 238 to obtain decoded data and control information sent by the UE 115. The eNodeB reception processor 238 may provide the decoded data to a eNodeB data sink 246 and the decoded control information to the eNodeB controller/processor 240. A scheduler 244 may be used to schedule the UE 115 for data transmission on the downlink and/or uplink.

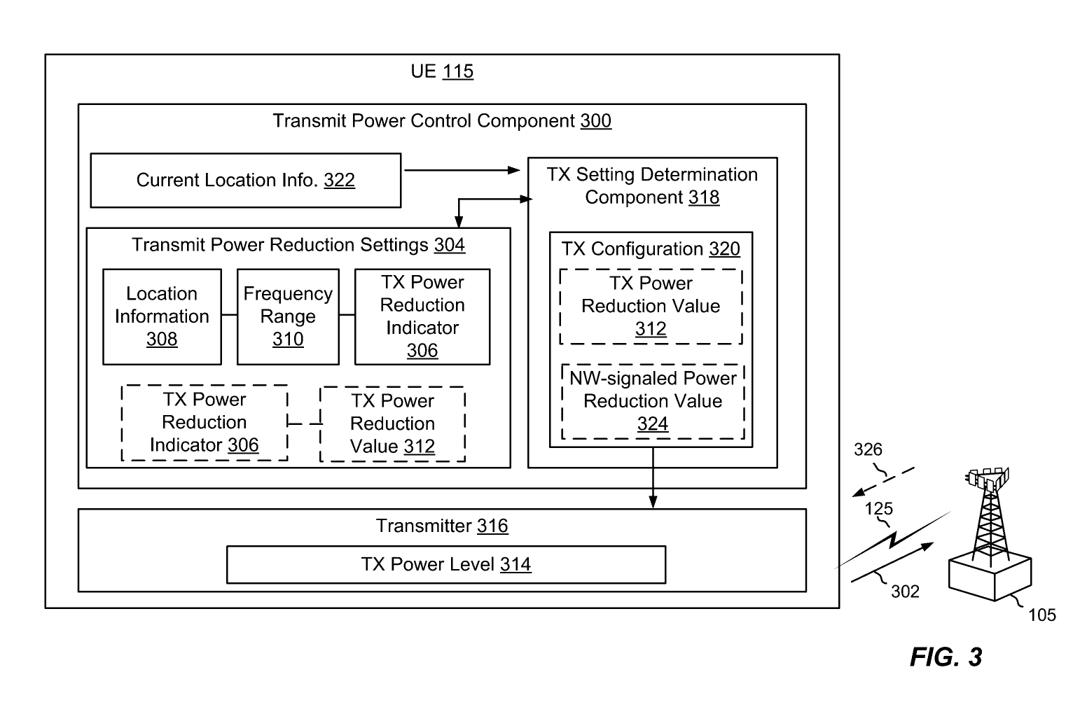

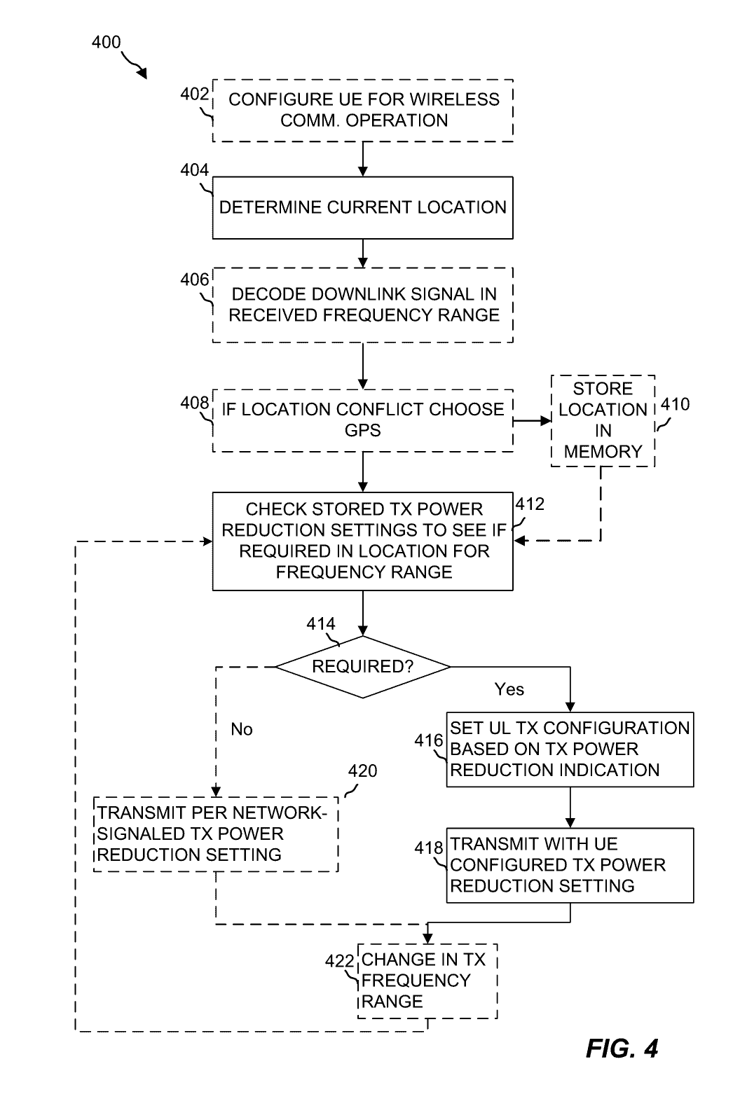

The eNodeB controller/processor 240 and the UE controller/processor 280 may direct the operation at the eNodeB 105 and the UE 115, respectively. The UE controller/processor 280 and/or other processors and modules at the UE 115 may also perform or direct actions of transmit power control component 300 (FIGS. 3, 6, and 7) and/or the execution of method 400 (FIG. 4). In some aspects, at least a portion of the execution of transmit power control component 300 and/or method 400 may be performed by the UE 115 operating transmit power control component 300 using the UE controller/processor 280. Alternatively, or in addition, the UE memory 282 may store data and program codes for the operation of transmit power control component 300.

In one configuration, the UE 115 may include means for performing the actions of method 400. In one aspect, the aforementioned means may be the UE controller/processor 280, the UE memory 282, the UE reception processor 258, the UE MIMO detector 256, the UE modulators/demodulators 254, and the UE antennas 252 configured to perform the functions recited by the aforementioned means. In another aspect, the aforementioned means may be a module, component, or any apparatus configured to perform the functions recited by the aforementioned means. Examples of such modules, components, or apparatus may be described with respect to FIGS. 3-7.

Referring to FIG. 3, in one example implementation, the UE 115 is configured with a transmit power control component 300 that operates to allow the UE 115 to self-control, e.g., without regard to network-transmitted signaling, a transmit power reduction or transmit power backoff used in transmitting an uplink transmission 302. The transmit power control component 300 may include, for example, a processor executing instructions stored in a memory or computer-readable storage medium. In one example, for instance, the UE 115 may operate transmit power control component 300 in order to meet regulatory emissions requirements and/or regulatory RF exposure requirements and/or any other regulatory requirements related to uplink transmission from the UE 115 that are associated with a current location and transmit frequency range used by the UE 115.

In particular, the UE 115 and/or transmit power control component 300 may store transmit power reduction settings 304 locally, e.g., in a memory or computer-readable storage medium of the UE 115. Transmit power reduction settings 304 may include, but are not limited to, one or more transmit power reduction indicators 306 corresponding to one or more locations, as defined by one or more sets of location information 308, and one or more frequency ranges 310. For example, each transmit power reduction indicator 306 may include, or may further correspond to, a transmit power reduction value 312 that defines an amount, e.g., in dB, that the UE 115 may reduce a transmit power level 314 of transmitter 316 when sending uplink transmission 302. For instance, in one implementation, each transmit power reduction indicator 306 may be or may correspond to a respective NS value as specified by 3GPP Technical Specifications, such as TS 36.101, and thus may correspond to a respective transmit power reduction value 312 that matches an A-MPR value used to meet regulatory emissions requirements and/or regulatory RF exposure requirements and/or any other regulatory requirements related to uplink transmission from the UE 115. Further, each transmit power reduction indicator 306 may be or may correspond to a respective transmit power reduction value 312 that is a fixed maximum power reduction value, such as but not limited to a value that satisfies all regulatory emissions requirements and/or regulatory RF exposure requirements and/or any other regulatory requirements related to uplink transmission from the UE 115. Also, for example, one or more sets of location information 308 may be a Mobile Country Code (MCC), and/or may be specific geographic coordinates (e.g., latitude and longitude values) or a range thereof, which also may correspond to a respective MCC. Further, for example, the one or more frequency ranges 310 may be, or may correspond to, one or any combination of an E-UTRA operating frequency band, a range of frequencies (e.g., such as a range of frequencies that may be associated with an E-UTRA operating frequency band) or frequency bandwidth, or a frequency channel (e.g., having a channel frequency bandwidth) or channel number (such as an enhanced absolute radio-frequency channel number (E-ARFCN)). For instance, in an implementation, location information 308 includes an MCC or specific geographic coordinates, and frequency range 310 includes both E-UTRA operating frequency band and E-ARFCN that may be used for uplink transmission 302.

In any case, transmit power control component 300 may further include a transmit setting determination component 318 that operates to configure a transmit configuration 320 having transmission parameters for use by transmitter 316 in sending uplink transmission 302. The transmit setting determination component 318 may include a processor executing instructions stored in a memory or computer-readable medium. In particular, according to the present aspects, transmit setting determination component 318 is operable to check whether current location information 322 (e.g., an MCC obtained from eNodeB 105 or geographic coordinates obtained from a satellite based positioning system, e.g., GPS) matches one of the one or more location information 308 locally-stored in transmit power reduction settings 304. When such a match is found, then transmit setting determination component 318 is operable to use the respective transmit power reduction indicator 306, and/or optionally the corresponding transmit power reduction value 312, to set a value of allowed transmit power reduction for transmit configuration 320 when sending uplink transmission 302 in the corresponding frequency range 310.

Alternatively, in an additional option, if transmit setting determination component 318 determines that locally-stored transmit power reduction settings 304 do not have location information 308 that matches current location information 322, then transmit setting determination component 318 can configure transmit configuration 320 using a network-signaled power reduction value 324 for uplink transmission 302 sent in a transmit frequency range. For example, network-signaled power reduction value 324 may include, but is not limited to, an NS value defined per 3GPP Technical Specification, which may be received in a network message 326, such as but not limited to a system information block (SIB). For instance, network-signaled power reduction value 324 may be a NS value identified in an information element (IE) (e.g., an AdditionalSpectrumEmission IE) in SIB2. Hence, in this situation, transmit setting determination component 318 determines that there is no locally-stored transmit power reduction indicator 306 associated with current location information 322, and therefore may rely on network message 326 including network-signaled power reduction value 324 for control of transmit power backoff used by transmitter 316 for uplink transmission 302 sent in a transmit frequency range.

As such, the present aspects enable the UE 115 to have local control of transmit power reduction settings 304, e.g., independent of network signaling, for example, to ensure that regulatory emissions requirements and/or regulatory RF exposure requirements and/or any other regulatory requirements related to uplink transmission from the UE 115 are met. Accordingly, in one scenario, the present aspects thereby avoid reliance on network operator compliance with providing network-signaled power reduction values that meet regulatory emissions requirements and/or regulatory RF exposure requirements and/or any other regulatory requirements related to uplink transmission from the UE 115.

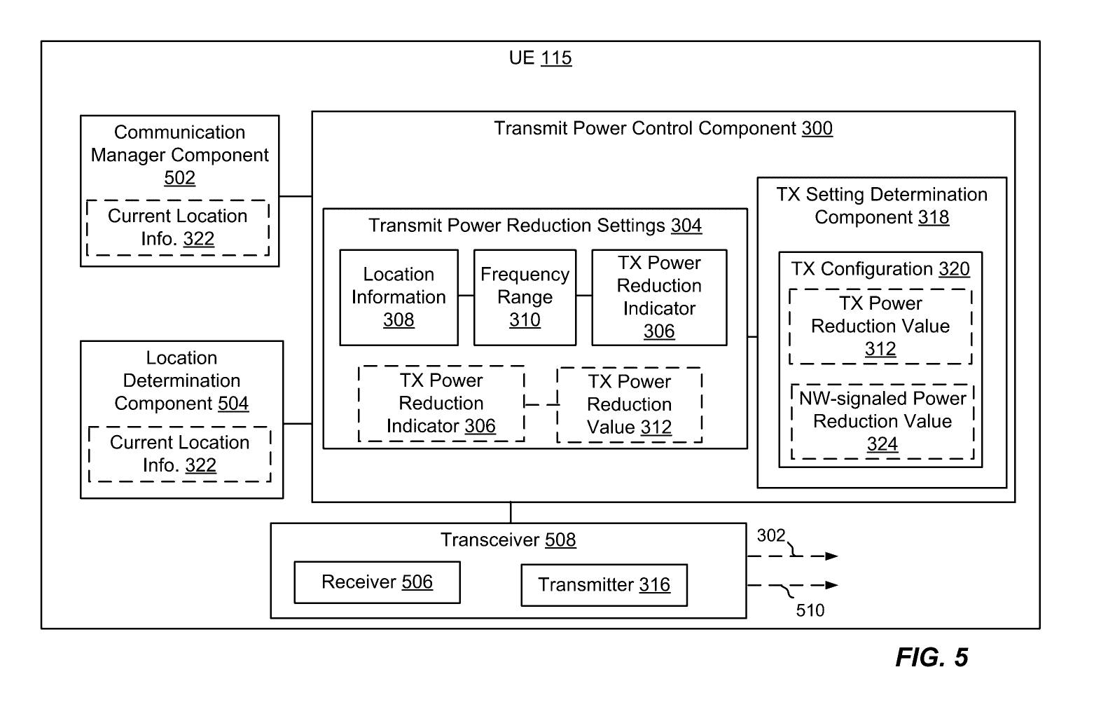

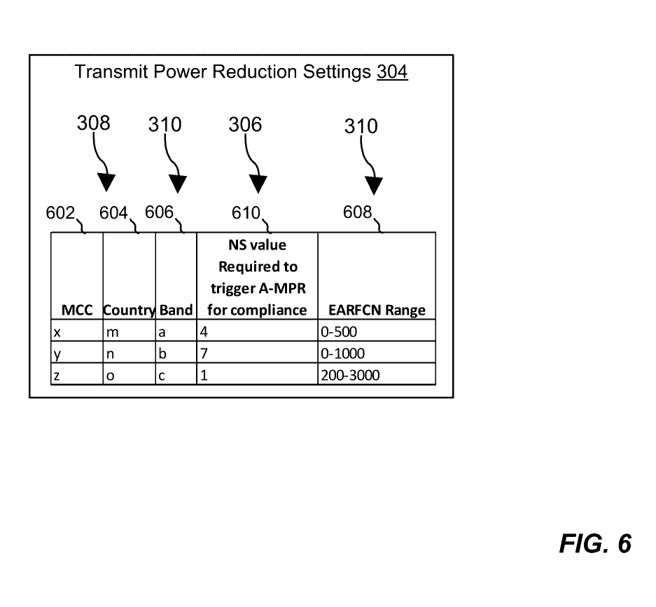

Referring to FIG. 4, an aspect of a method 400 of controlling a transmit power of a user equipment (UE) in a wireless communication network is discussed with reference to FIGS. 5 and 6, which provide additional details regarding components of UE 115 that cooperate in the performance of method 400. Although the operations described below with respect to these figures are presented in a particular order and/or as being performed by an example component, it should be understood that the ordering of the actions and the components performing the actions may be varied, depending on the implementation. Moreover, it should be understood that the following actions or functions may be performed by a specially-programmed processor configured with transmit power control component 300 as described herein, a processor executing specially-programmed software or computer-readable media having instructions that carry out the actions transmit power control component 300 as described herein, or by any other combination of a hardware component and/or a software component capable of performing the described actions of transmit power control component 300 as described herein.

Method 400 optionally (as indicated by the dashed line) includes, at block 402, configuring a UE for wireless communication operation. Such wireless communication operation may utilize any suitable wireless communication technology including but not limited to Long-Term Evolution (LTE), Wireless Wide Area Network (WWAN) technology, Wireless Local Area Network (WLAN) technology, or other short range technologies such as Bluetooth, Zigbee, etc. For example, in an aspect, the UE 115 may include a communications manager component 502 operable to configure the UE 115 for wireless communications, such as communications with eNodeB 105. Communications manager component 502 may include one or more modules, such as hardware, software/computer-readable instructions stored on a memory or computer-readable medium and executable by a processor, or a combination thereof, which are specially programmed based on wireless communications standards to enable the UE 115 to communicate wirelessly. For instance, in an aspect that should not be construed as limiting, communications manager component 502 may be programmed based on one or more 3GPP Technical Specifications, such as for configuring the UE 115 for operation on radio access network that operates according to LTE standards. In one implementation, for example, configuring the UE 115 for wireless communication operation includes communications manager component 502 performing one or more procedures for identifying cells on which to camp and/or for setting up a call with one or more cells. In other words, method 400 may be initiated at the UE 115 based on the UE 115 being configured for wireless communication including when the UE 115 is initially powered on and performing a cell searching procedure, and/or based on an idle mode cell reselection procedure and/or an active mode handover procedure from one cell to another.

At block 404, method 400 includes determining a current location of the UE. For example, in an aspect, the UE 115 and/or communications manager component 502 and/or a location determination component 504 may determine or may obtain current location information 322 that identifies the current location of the UE 115. In an aspect, for example, communications manager component 502 may obtain current location information 322 in the form of an MCC value based on reception of a network message, such as a SIB, by a receiver 506 that is a portion of a transceiver 508 of the UE 115. In another aspect, for example, location determination component 504 may determine current location information 322 in the form of specific geographic coordinates (e.g., latitude and longitude values), and/or in the form of an MCC value that may be correlated to the specific geographic coordinates. For example, location determination component 504 may include one or more modules, such as hardware, software/computer-readable instructions stored on a memory or computer-readable medium and executable by a processor, or a combination thereof, which are specially programmed to carry out position/location procedures, such as procedures associated with at least one of a terrestrial-based positioning system (e.g., WWAN or WLAN based triangulation systems), a satellite-based positioning system (e.g., GPS, GLObal NAvigation Satellite System (GLONASS), etc.), or a combination thereof.

At block 406, method 400 optionally (as indicated by the dashed line) includes decoding a downlink signal received in a frequency range at the UE. For example, in an aspect, the UE 115 and/or communications manager component 502 in combination with receiver 506 of transceiver 508 is operable to decode a downlink signal received in a frequency range at the UE 115. For example, the decoded downlink signal may include a SIB having an MCC that can be used to determine current location information 322.

At block 408, method 400 optionally (as indicated by the dashed line) includes choosing a position/location-based determination of the current location as a preferred value of the current location if a conflict exists with a network-signaled information regarding the current location. For example, in an aspect, transmit setting determination component 318 may include one or more modules, such as hardware, software/computer-readable instructions stored on a memory or computer-readable medium and executable by a processor, or a combination thereof, which are specially programmed to determine if a current location associated with different sources (e.g., location determination component 504, communications manager component 502, or network-signaling) of current location information 322 provide different current locations, and for selecting the current location corresponding to current location information 322 provided by location determination component 504 as the valid current location. For instance, block 408 may be implemented by method 400 when the UE 115 is located near a border between two countries or regions or locations with different transmit power reduction indicators 306. For instance, if the UE 115 is located in the United States (US) but locked onto a Canada/Mexico carrier (e.g., a foreign MCC), then current location information 322 as determined by location determination component 504 would indicate to transmit power control component 330 that the UE 115 is actually in the US and thus defines the applicable regulatory emissions requirements and/or regulatory RF exposure requirements and/or any other regulatory requirements related to uplink transmission from the UE 115.

At block 410, method 400 optionally (as indicated by the dashed line) includes storing the selected current location in a memory of the UE. For example, in an aspect, transmit setting determination component 318 may include one or more modules, such as hardware, software/computer-readable instructions stored on a computer-readable medium and executable by a processor, or a combination thereof, which are specially programmed to store current location information 322 in a memory at the UE 115. For instance, the memory of the UE 115 is accessible by transmit setting determination component 318 for use in comparing current location information 322 to one or more location information 308 of transmit power reduction settings 304, as described below. From block 410, the method 400 may proceed to block 412.

At block 412, method 400 includes checking stored transmit power reduction settings to see if transmit power reduction is required in the current location and for a transmit frequency range of the UE. For example, in an aspect, transmit setting determination component 318 may include one or more modules, such as hardware, software/computer-readable instructions stored on a memory or computer-readable medium and executable by a processor, or a combination thereof, which are specially programmed to check a set of transmit power reduction settings 304 stored in a memory of the UE 115 to determine whether power reduction indicator 306 is found for the location (e.g., where current location information 322 matches one of the one or more location information 308) and for frequency range 310 of uplink transmission 302 by UE 115. Checking the stored transmit power reduction settings may include identifying, from the set of transmit power reduction settings stored in the memory of the UE 115, a power reduction indicator corresponding to the current location and to a frequency range of an uplink transmission by the UE 115. Further, the transmit setting determination component 318 may determine a value of the power reduction indicator 306. The value of the power reduction indicator 306 may correspond to a network signaling (NS) value. In an aspect, one or more values of the power reduction indicator 306 may indicate that no power reduction is necessary. For example, a value of NS_01 may indicate that no power reduction is necessary.

For example, referring to FIGS. 3 and 5, one aspect of transmit power reduction settings 304 includes a first set of relationships between one or more of a set of location information 308, transmit frequency range 310, and transmit power reduction indictor 306, as described above. The first set of relationships may be used to determine a power reduction indicator for the current location and for a frequency range of an uplink transmission by the UE 115. For example, the transmit setting determination component 318 may determine a transmit power reduction indicator 306 corresponding to location information 308 matches the current location, and a frequency range 310 matches the frequency range for the uplink transmission.

Further, as another example, referring to FIG. 6, one aspect of transmit power reduction settings 304 includes a first set of relationships between one or more of a set of location information 308, transmit frequency range 310, and transmit power reduction indicator 306. The location information 308 may include an MCC value 602 and/or a country value 604. The MCC value may be compared to an MCC value signaled by the network. The country value 604 may include a country identifier and may be compared to a country identifier determined based on geographic coordinates determined based on a satellite-based positioning system signal. The transmit frequency range 310 may include a band value 606 and/or an E-ARFCN range 608. A transmit frequency to be used for an uplink transmission may be compared to the band value 606 and/or the E-ARFCN range 608. The transmit power reduction indictor 306 may be an NS value 610 required to trigger A-MPR for compliance.

At block 414, method 400 includes determining whether a transmit power reduction is a required based on the checking at block 412. For example, in an aspect, transmit setting determination component 318 is operable to identify whether or not a match exists between current location information 322 and any of the one or more location information 308 of transmit power reduction settings 304, and to further configure transmit configuration 320 to transmitter 316 based on whether or not a match is found and/or a value of a matching transmit power reduction indicator 306.

When the determination at block 414 is that there is a transmit power reduction required based on the checking at block 412 (e.g., a power reduction indicator is identified), then method 400 at block 416 includes setting an uplink transmit configuration based on the transmit power reduction indicator found at block 412 for the location and the frequency range. For example, in an aspect, transmit setting determination component 318 may include one or more modules, such as hardware, software/computer-readable instructions stored on a memory or computer-readable medium and executable by a processor, or a combination thereof, which are specially programmed to set uplink transmit configuration 320 based on the respective transmit power reduction indicator 306 found at block 412 for the location (e.g., location information 308 corresponding to current location information 322) and transmit frequency range 310 of uplink transmission 302. Moreover, as explained above, each transmit power reduction indicator 306 of transmit power reduction settings 304 may include, but are not limited to, a respective NS value as specified by 3GPP Technical Specifications, such as TS 36.101, and thus may correspond to a respective transmit power reduction value 312 that matches an A-MPR value used to meet regulatory emissions requirements and/or regulatory RF exposure requirements and/or any other regulatory requirements related to uplink transmission from the UE 115. Further, in another implementation, each transmit power reduction indicator 306 may be or may correspond to a respective transmit power reduction value 312 that is a fixed maximum power reduction value, such as but not limited to a value that satisfies all regulatory emissions requirements and/or regulatory RF exposure requirements and/or any other regulatory requirements related to uplink transmission from the UE 115. Moreover, in an aspect, each transmit power reduction indicator 306 may further correspond to a transmit power reduction value 312 that defines an amount, e.g., in dB, that UE 115 may reduce a transmit power level 314 of transmitter 316 when sending uplink transmission 302.

Further, at block 418, method 400 includes transmitting an uplink transmission with the UE-configured uplink transmit configuration configured at block 416 for the location and the frequency range. For example, in an aspect, transmitter 316 of the UE 115 is configured with transmit configuration 320 determined by transmit setting determination component 318, may transmit a first uplink transmission (e.g., uplink transmission 302) in the frequency range 310 at a first value of transmit power level 314 (see FIG. 3) controlled based on power reduction indicator 306 when the power reduction indicator 306 is found in the memory of the UE 115 for the current location as defined by current location information 322 matching location information 308 in the locally-stored transmit power reduction settings 304. For example, the transmit configuration 320 may set a maximum gain value for an amplifier of the transmitter 316.

Alternatively, in an aspect, when the determination at block 414 is that no transmit power reduction is indicated based on the checking at block 412 (e.g. no power reduction indicator is identified), then, at block 420, method 400 optionally (as indicated by the dashed line) includes transmitting an uplink transmission with a network-signaled transmit power reduction setting for the location and the frequency range. For example, in this alternative, transmitter 316 of the UE 115 is configured with transmit configuration 320 determined by transmit setting determination component 318, may transmit a second uplink transmission (e.g., uplink transmission 510) in the frequency range at a second value of transmit power level 314 controlled based on network-signaled power reduction value 324 received by receiver 506 of the UE 115 when power reduction indicator 306 is not found in the memory of the UE 115 for the current location (e.g., as defined by current location information 322 matching location information 308), which may be a second location that is different from a first current location for which a matching transmit power reduction indicator 306 was found. For example, when the UE 115 moves from a first location to the second location, a value of the current location may change such that no matching transmit power reduction indicator 306 is found for the second location. In an aspect, as discussed above, network-signaled power reduction value 324 may be any value signaled by eNodeB 105, such as but not limited to an NS value associated with 3GPP Technical Specifications and corresponding to an A-MPR value.

At block 422, method 400 optionally (as indicated by the dashed line) includes determining a change in the transmit frequency range and returning method 400 to block 412 to check the stored transmit power reduction settings to see if transmit power reduction is required in the current location and for the new transmit frequency range of the UE. For example, in an aspect, transmit setting determination component 318 may include one or more modules, such as hardware, software/computer-readable instructions stored on a memory or computer-readable medium and executable by a processor, or a combination thereof, which are specially programmed to communicate with communications manager component 502. The communications manager component 502 may be configured to cause the UE 115 to change transmit frequency range, or an operating frequency band (e.g., E-UTRA operating band) and channel (e.g., E-ARFCN). In response, the transmit setting determination component 318 can re-initiate aspects of method 400 beginning at block 412 to check the stored transmit power reduction settings 304 to see if transmit power reduction indicator 306 is required in the current location (e.g., based on current location information 322 matching location information 308) and for the new transmit frequency range.

Thus, method 400 defines one example of operation of transmit power control component 300 by the UE 115 to enable UE-centric control of transmit power reduction or power backoff configurations used by the UE 115, e.g., independent of network signaling.

Accordingly, in one implementation, the described aspects specially configure a UE to ensure compliance with regional regulatory emissions requirements and/or regulatory RF exposure requirements and/or any other regulatory requirements related to uplink transmission from the UE, which may also include fully complying with 3GPP conformance requirements and test procedures.

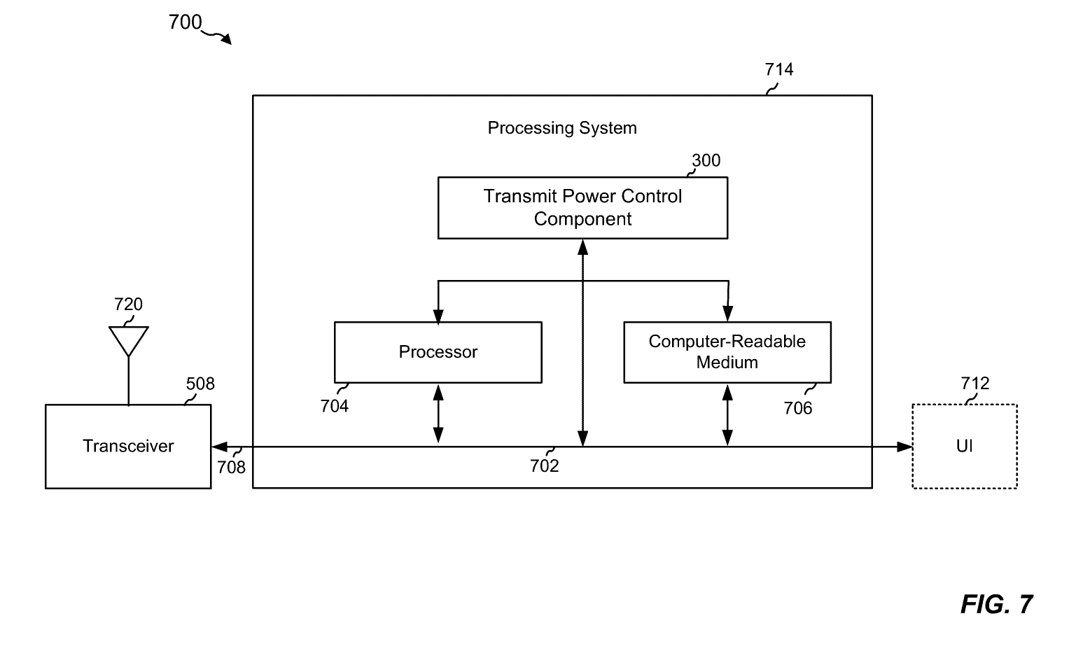

Referring to FIG. 7, an apparatus 700 employs a processing system 714 configured in accordance with an aspect of the present disclosure to operate transmit power control component 300 according to one or more aspects describe herein. For example, transmit power control component 300 may be defined in computer-readable instructions stored in computer-readable medium 706 and executed by processor 704, or as one or more processor modules that form a part of processor 704, or some combination of both. In one example, the apparatus 700 may be the same as, similar to, or included within the UE 115 as described in various Figures. As such, transmit power control component 300 may include or otherwise be coupled to the components described herein to provide the functions described herein.

In this example, the processing system 714 may be implemented with a bus architecture, represented generally by the bus 702. The bus 702 may include any number of interconnecting buses and bridges depending on the specific application of the processing system 714 and the overall design constraints. The bus 702 links together various circuits including one or more processors (e.g., central processing units (CPUs), microcontrollers, application specific integrated circuits (ASICs), field programmable gate arrays (FPGAs)) represented generally by the processor 704, and computer-readable media, represented generally by the computer-readable medium 706. The bus 702 may also link various other circuits such as timing sources, peripherals, voltage regulators, and power management circuits, which are well known in the art, and therefore, will not be described any further. A bus interface 708 provides an interface between the bus 702 and transceiver 508, which is connected to one or more antennas 720 for receiving or transmitting signals. The transceiver 508 and the one or more antennas 720 provide a mechanism for communicating with various other apparatus over a transmission medium (e.g., over-the-air). Depending upon the nature of the apparatus, a user interface (UI) 712 (e.g., keypad, display, speaker, microphone, joystick) may also be provided.

The processor 704 is responsible for managing the bus 702 and general processing, including the execution of software stored on the computer-readable medium 706. The software, when executed by the processor 704, causes the processing system 714 to perform the various functions of transmit power control component 300 described herein for any particular apparatus. The computer-readable medium 706 may also be used for storing data that is manipulated by the processor 704 when executing software. Accordingly, as noted above, transmit power control component 300 as described herein may be implemented in whole or in part by processor 704, or by computer-readable medium 706, or by any combination of processor 704 and computer-readable medium 706.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but it is to be accorded the widest scope consistent with the principles and novel features disclosed herein.

What is claimed:

1. A method of controlling a transmit power of a user equipment (UE) in a wireless communication network, comprising:
determining, at a processor of the UE, a location of the UE;
identifying, from a set of transmit power reduction settings stored in a memory of the UE, a power reduction indicator corresponding to the location and to a frequency range of an uplink transmission by the UE; and
transmitting, by a transmitter of the UE, a first uplink transmission in the frequency range at a first transmit power controlled based on the power reduction indicator.

2. The method of claim 1, further comprising:
checking the set of transmit power reduction settings stored in the memory of the UE for a second location that is different than the location;
determining that a power reduction indicator is not found in the memory of the UE corresponding to the second location; and
transmitting, by the transmitter, a second uplink transmission in the frequency range at a second transmit power controlled based on a network-signaled power reduction value received by a receiver of the UE when the power reduction indicator corresponding to the second location is not found in the memory of the UE.

3. The method of claim 1,
wherein determining the location of the UE comprises determining the location based on geographic coordinates or a mobile country code.

4. The method of claim 3, further comprising:
determining that a location based on the geographic coordinates conflicts with a location based on the mobile country code; and
setting the location based on the geographic coordinates.

5. The method of claim 1, wherein identifying, from the set of transmit power reduction settings, further comprises obtaining a transmit power reduction value based on the power reduction indicator when the location matches location information corresponding to the power reduction indicator in the set of transmit power reduction settings.

6. The method of claim 5, wherein the power reduction indicator stored in the memory of the UE corresponds to a network signaling (NS) value and the transmit power reduction value corresponds to an Additional Maximum Power Reduction (A-MPR) value.

7. The method of claim 5, wherein transmitting the first uplink transmission comprises transmitting using a transmit configuration based on the transmit power reduction value.

8. The method of claim 1, further comprising:
receiving a network signaled power reduction indicator; and
selecting the power reduction indicator stored in the memory of the UE for the location instead of the network signaled power reduction indicator.

9. The method of claim 1, wherein transmitting the first uplink transmission comprises limiting the first transmit power to a maximum transmission power selected based on the power reduction indicator.

10. A user equipment (UE) for transmitting communications in a wireless communication network, comprising:
a memory having a set of transmit power reduction settings including one or more power reduction indicators each corresponding to location information and a transmit frequency range;
a processor having a transmit power control component configured to:
determine a location of the UE;
identify, from the set of transmit power reduction settings stored in the memory of the UE, a power reduction indicator corresponding to the location and to a frequency range of an uplink transmission by the UE; and
a transmitter configured to transmit a first uplink transmission in the frequency range at a first transmit power controlled based on the power reduction indicator.

11. The UE of claim 9, wherein the processor is further configured to transmit a second uplink transmission in the frequency range at a second transmit power controlled based on a network-signaled power reduction value when the set of transmit power reduction settings stored in the memory of the UE does not include a power reduction indicator corresponding to the location.

12. The UE of claim 10, further comprising a receiver that determines the location of the UE based on a received satellite-positioning system signal or a received mobile country code.

13. The UE of claim 12, wherein the processor is further configured to:
determine that a location based on the received satellite-positioning system signal conflicts with a location based on the received mobile country code; and
set the location based on the received satellite-positioning system signal.

14. The UE of claim 10, wherein the processor is further configured to obtain a transmit power reduction value based on the identified power reduction indicator when the location matches location information corresponding to the power reduction indicator in the set of transmit power reduction settings.

15. The UE of claim 14, wherein the power reduction indicator stored in the memory of the UE corresponds to a network signaling (NS) value and the transmit power reduction value corresponds to an Additional Maximum Power Reduction (A-MPR) value.

16. The UE of claim 14, wherein the transmitter is configured using a transmit configuration based on the transmit power reduction value.

17. The UE of claim 16, wherein the transmit configuration limits the first transmit power to a maximum transmission power selected based on the power reduction indicator.

18. The UE of claim 10, wherein the processor is further configured to:
receive a network signaled power reduction indicator; and
select the power reduction indicator stored in the memory of the UE for the location instead of the network signaled power reduction indicator.

19. A user equipment (UE) for transmitting communications in a wireless communication network, comprising:
means for determining a location of the UE;
means for identifying, from a set of transmit power reduction settings stored in a memory of the UE, a power reduction indicator corresponding to the location and to a frequency range of a first uplink transmission from the UE; and
means for transmitting at a transmit power level based on the power reduction indicator stored at the UE.

20. The UE of claim 19, further comprising:
means for transmitting at a transmit power level based on a network-signaled transmit power reduction value received by a receiver of the UE when the power reduction indicator corresponding to the location of the UE is not found in the set of transmit power reduction settings stored in the memory of the UE.

21. The UE of claim 19, wherein the means for determining the location of the UE comprises means for determining the location based on geographic coordinates or a mobile country code.

22. The UE of claim 21, wherein the means for determining the location of the UE are for determining that a location based on the geographic coordinates conflicts with a location based on the mobile country code; and for setting the location based on the geographic coordinates.

23. The UE of claim 19, wherein the means for identifying the power reduction indicator from the set of transmit power reduction settings are for obtaining a transmit power reduction value based on the power reduction indicator when the location matches location information corresponding to the power reduction indicator in the set of transmit power reduction settings.

24. The UE of claim 23, wherein the power reduction indicator stored in the memory of the UE corresponds to a network signaling (NS) value and the transmit power reduction value corresponds to an Additional Maximum Power Reduction (A-MPR) value.

25. The UE of claim 23, wherein the means for transmitting the first uplink transmission transmits using a transmit configuration based on the transmit power reduction value.

26. The UE of claim 19, wherein the means for transmitting the first uplink transmission limits the first transmit power to a maximum transmission power selected based on the power reduction indicator.

27. A non-transitory computer-readable storage medium storing computer-executable code for controlling a transmit power of a user equipment (UE) in a wireless communication network, comprising:
code executable by a processor to determine a location of the UE;
code executable by the processor to identify, from a set of transmit power reduction settings stored in a memory of the UE, a power reduction indicator corresponding to the location and to a frequency range of a transmission from the UE; and
code executable by the processor to transmit at a transmit power level based on the identified power reduction indicator stored in the memory of the UE.

28. The non-transitory computer-readable storage medium of claim 27, further comprising:
code executable by the processor to transmit at a transmit power level based on a network-signaled transmit power reduction value received by a receiver of the UE when the power reduction indicator corresponding to the location of the UE is not found in the set of transmit power reduction settings stored at the UE.

29. The non-transitory computer-readable storage medium of claim 27, wherein identifying, from the set of transmit power reduction settings further comprises obtaining a transmit power reduction value based on the power reduction indicator when the location matches location information corresponding to the power reduction indicator in the set of transmit power reduction settings.

30. The non-transitory computer-readable storage medium of claim 29, wherein the power reduction indicator stored in the memory of the UE corresponds to a network signaling (NS) value and the transmit power reduction value corresponds to an Additional Maximum Power Reduction (A-MPR) value.
